(19) United States
(12) Patent Application Publication
(10) Pub. No.: US 2014/0242556 A1
(43) Pub. Date: Aug. 28, 2014

(54) DIET MANAGEMENT SYSTEM AND METHOD

(71) Applicant: AMOREPACIFIC CORPORATION, Seoul (KR)

(72) Inventors: Lang Gook Yoo, Seoul (KR); Sung Hee Park, Seoul (KR); Jung Ki Min, Seoul (KR); Eun Kyung Seo, Seoul (KR); Hyun Woo Park, Seoul (KR); Sang Jun Lee, Yongin-si (KR); Sung Won Cho, Hwaseong-si (KR)

(73) Assignee: AMOREPACIFIC CORPORATION, Seoul (KR)

(21) Appl. No.: 14/347,032

(22) PCT Filed: Nov. 15, 2012
(86) PCT No.: PCT/KR2012/009681

§ 371 Date: Mar. 25, 2014

(30) Foreign Application Priority Data
Nov. 15, 2011 (KR) 10-2011-0118988

(51) Int. Cl. G09B 19/00

(52) U.S. Cl. CPC G09B 19/0092
USPC 434/127

(57) ABSTRACT

The present invention relates to a diet management system and method, wherein individual information data about users going through diet management are received and users are classified by body morphology, and a user-specific customised solution is provided in accordance with user body morphology classification-based diet targets, lifestyle analysis results and condition diagnostic data, and the user's current circumstances are received and a customised solution is provided that has been changed to match therewith. The present invention makes it possible to provide, in timely fashion, a solution wherein systemic diet management is effected that matches the characteristics of each individual person who is dieting, and wherein changes are effected so as to reflect the current condition of the person who is dieting.

### TECHNICAL FIELD

The present invention relates to a diet management system and method. More specifically, the present invention relates to a system and method for receiving personal information data of a user going through diet management, classifying the user by body type, providing a user-specific tailor-made solution based on a diet goal according to body type classification of the user, a lifestyle analysis result, and a state diagnosis data, receiving a current state of the user, and providing the tailor-made solution modified to be suitable for the current state.

### BACKGROUND ART

As modern society is gradually westernized and industrialized, the number of overweight or obese people is increased. Since overweight or obesity is a cause of various diseases such as adult disease or the like, a lot of people are on a diet to solve the problem of overweight or obesity. In addition, as the tendency of pursuing well-being and a desire for beauty is increased recently, the diet tends to be spotlighted as a way to a pleasant life, not simply a way of solving the problem of overweight or obesity for health.

Accordingly, diet methods also have been developed diversely. However, if a person goes on a diet alone, it is easy to give up the diet halfway or difficult to effectively go on the diet, and thus a lot of people join a dietary specialty site or register in a facility operating a diet management program and utilize various recommended menus, recommended exercises or recommended medicines provided by the specialty site or facility.

However, since a diet management system currently provided by the dietary specialty site or the facility operating a diet management program provides standardized information and program for a plurality of users although characteristics of individual dieters are different, an effective diet cannot be accomplished in many cases. In addition, although a customized diet program is provided, there is a problem in that the program is not systematic or even poor in many cases.

Furthermore, although it needs to timely provide a modified solution reflecting the current state of a dieter for an effective diet even after a solution is provided, there is a problem in that such a modified solution is not provided at an appropriate time.

### DISCLOSURE OF INVENTION

### Technical Problem

Therefore, the present invention has been made in view of the above problems, and it is an object of the present invention to a system and method for receiving personal information data of a user going through diet management, classifying the user by body type, providing a user-specific tailor-made solution based on a diet goal according to body type classification of the user, a lifestyle analysis result, and a state diagnosis data, receiving a current state of the user, and providing the tailor-made solution modified to be suitable for the current state.

### Solution to Problem

To accomplish the above object, according to one aspect of the present invention, there is provided a diet management system: including a database for storing a personal information data including a state diagnosis data and a lifestyle data of a user received from a diet management server and a solution data; the diet management server including a data transmission and reception unit connected to communicate with the database, an information input terminal and a user terminal and capable of transmitting and receiving data, a body type classification operation unit for creating a body type classification data by classifying the user by body type according to an obesity level and a body shape using the state diagnosis data received through the data transmission and reception unit, a lifestyle analysis unit for creating a lifestyle analysis result of the user according to the lifestyle data received through the data transmission and reception unit, a solution creation unit for creating or modifying a user-specific tailor-made solution appropriate to a diet goal of the user based on the body type classification data using a solution data DB according to the lifestyle analysis result or a current state of the user and the state diagnosis data, and a personalized service providing unit for receiving the current state of the user from the user terminal through the data transmission and reception unit and transmitting the tailor-made solution modified to be suitable for the current state of the user to the user terminal through the data transmission and reception unit; the information input terminal connected to communicate with the diet management server and inputting the personal information data of the user; and the user terminal connected to communicate with the diet management server and capable of receiving the current state of the user from the user and outputting the modified tailor-made solution.

According to another aspect of the present invention, there is provided a diet management method of a diet management system including: a diet management server, a database connected to the diet management server and storing a personal information data including a state diagnosis data and a lifestyle data of a user received from the server and a solution data, an information input terminal connected to communicate with the diet management server and inputting the personal information data, and a user terminal connected to communicate with the diet management server and capable of receiving a current state from the user and outputting a modified tailor-made solution, the method comprising the steps of: (a) creating a body type classification data by classifying the user by body type according to an obesity level and a body shape using the state diagnosis data received from a state diagnosis data DB through a data transmission and reception unit of the diet management server, and storing the created body type classification data into a body type classification data DB of the database; (b) creating a lifestyle analysis result of the user according to the lifestyle data of the user received from a lifestyle data DB through the data transmission and reception unit of the diet management server; (c) creating a user-specific tailor-made solution appropriate to a diet goal of the user based on the body type classification data using a stored solution data DB according to the lifestyle analysis result and the state diagnosis data, by the diet management server; and (d) receiving the current state of the user from the user terminal through the data transmission and reception unit of the diet management server, modifying the tailor-made solution to be suitable for the current state of the user, and transmitting the tailor-made solution modified to be suitable for the current state of the user to the user terminal through the data transmission and reception unit.

### Advantageous Effects of Invention

According to the present invention, systematic diet management suitable for characteristics of an individual dieter can be accomplished, and a modified solution reflecting the current state of the dieter may be timely provided.

### BRIEF DESCRIPTION OF DRAWINGS

The above and other objects, features and advantages of the present invention will be apparent from the following detailed description of the preferred embodiments of the present invention in conjunction with the accompanying drawings, in which:

FIG. 1 is a view schematically showing a diet management system according to an embodiment of the present invention;

FIG. 2 is a view schematically showing a diet management server and a database configuring a diet management system according to an embodiment of the present invention;

FIG. 3 is a flowchart illustrating the operation of a diet management server 100 in a diet management system according to an embodiment of the present invention;

FIG. 4 is a table showing body type classification criteria according to an embodiment of the present invention;

FIG. 5 is a detailed flowchart of step 320 shown in FIG. 3;

FIG. 6 is a detailed flowchart of step 340 shown in FIG. 3; and

FIG. 7 is a view schematically showing a tailor-made solution according to an embodiment of the present invention.

### MODE FOR THE INVENTION

In the present invention, a user is a person on a diet, which means a person using a diet program provided by a diet management system according to an embodiment of the present invention.

In the present invention, a service provider is a person providing the user with a diet program using a diet management system according to an embodiment of the present invention.

The preferred embodiments of the present invention will be hereafter described in detail with reference to the accompanying drawings. In addition, in describing the operating principles of the preferred embodiments of the present invention in detail, if already known functions or specific description of constitution related to the present invention may make the spirit of the present invention unclear, detailed description thereof will be omitted.

Terms and words used in this specification and claims should be interpreted as meanings and concepts to meet the technical ideas of the invention based on the principles that can define adequately the concept of the terms so that the inventor can explain his or her invention in the best way. Since the embodiments described in the specification and the configurations shown in the drawings are merely preferred embodiments and do not represent the spirits of the present invention, it should be understood that various equivalents and modified examples which can substitute the embodiments at the time point of filing this application can be made.

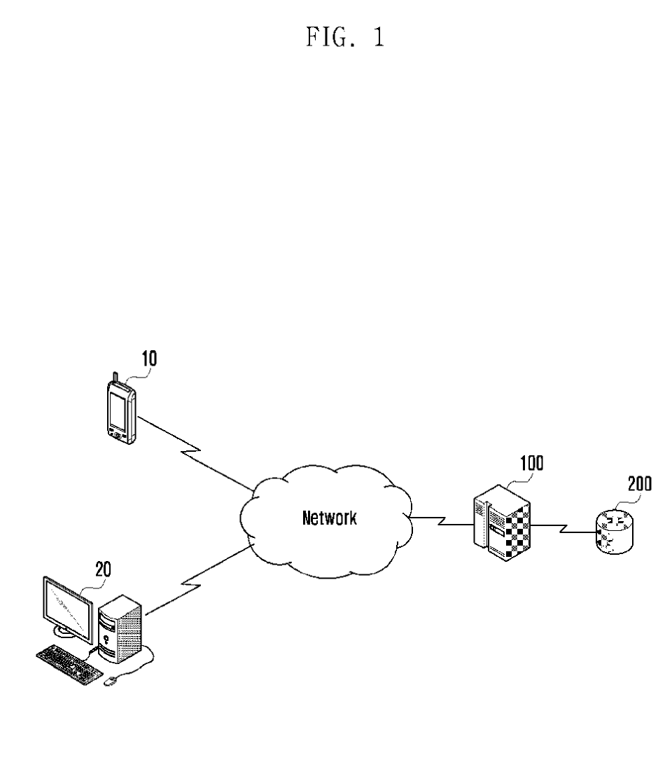

FIG. 1 is a view schematically showing a diet management system according to an embodiment of the present invention;

As shown in FIG. 1, the diet management system according to an embodiment of the present invention may be configured of a user terminal 10, an information input terminal 20, a diet management server 100 and a database 200.

The user terminal 10 may receive a current state of a dieter (hereinafter, referred to as a ‘user’) from the user, transmit the current state to the diet management server 100, receive a modified tailor-made solution from the diet management server 100, and output and display the modified tailor-made solution to the user.

The information input terminal 20 may receive personal information data of the user from a person providing a diet program (hereinafter, referred to as a ‘service provider’) or the user using the diet management system according to an embodiment of the present invention and transmit the personal information data to the diet management server 100.

According to an embodiment of the present invention, the service provider contacts with the user at a diet center, at a marketing process, on a door-to-door sale or on an on-line space. After contacting with the user, the service provider acquires personal information of the user. The service provider acquires profile information such as a name, a sex, an age and the like of the user, and lifestyle information such as living habits of the user, a motive of diet, hindrance of diet and the like through a questionnaire. In addition, the service provider acquires state diagnosis information through state diagnosis of the user. The state diagnosis includes diagnosis of obesity, diagnosis of body shape and diagnosis of skin. The service provider acquires a BMI of the user through in-body measurement to diagnose obesity of the user and acquires a body shape analysis result through a three-dimensional body shape analysis in order to diagnose the body shape of the user. In addition, a result of the skin diagnosis is acquired through an oxygen saturation measurement, a skin surface test, and an elasticity test.

The service provider inputs the acquired personal information into the information input terminal 20. At this point, the input may be directly performed by the user, or the information input terminal 20 may directly conduct the questionnaire. In addition, the diet management server 100 may directly transmit the questionnaire to the user terminal 10 through a data transmission and reception unit 110, and the user may input a result of the questionnaire into the user terminal 10 and transmit the result to the data transmission and reception unit 110 of the diet management server 100 in response thereto. In this case, the user terminal 10 and the information input terminal 20 are the same terminal. In this case, input of the user information, input of the current state of the user and output of a modified tailor-made solution may be accomplished through one terminal.

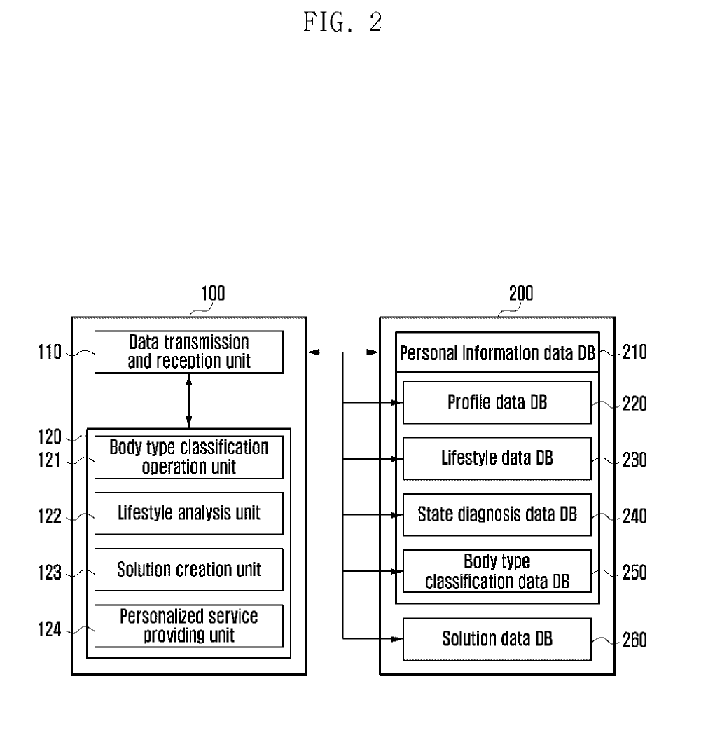

The database 200 is connected to communicate with the diet management server 100 and may store the data received from the diet management server 100. According to an embodiment of the present invention, a solution data is previously stored in the database 200. In addition, the database 200 may store personal information data including a state diagnosis data and a lifestyle data of the user received from the diet management server 100 and also store a body type classification data. The detailed configuration of the database 200 according to an embodiment of the present invention will be described below with reference to FIG. 2. Furthermore, the database 200 may be installed in an electronic data processing device, together with the diet management server 100.

The diet management server 100 may communicated with the user terminal 10, the information input terminal 20 and the database 200, store personal information data of the user received from the information input terminal 200 into the database 200, create a user-specific tailor-made solution using the personal information data of the user and the solution data, and provide the tailor-made solution modified to be suitable for the current state of the user received from the user terminal 10. The detailed configuration of the diet management server 100 will be described below with reference to FIG. 2.

According to another embodiment of the present invention, the diet management system may further include a web server (not shown) operated by the service provider. In this case, the web server is connected to an Internet network to communicate with the user terminal 10, the information input terminal 20 and the diet management server 100. When the web server is further included, the user terminal 10 and the information input terminal 20 may transmit data to the web server through the Internet network, and the web server may receive and provide the data to the diet management server 100. The diet management server 100 may also transmit data to the web server, and the web server may receive and transmit the data to the user terminal 10 and the information input terminal 20 through the Internet network. Furthermore, the web server (not shown) may be installed in an electronic data processing device, together with the diet management server 100.

FIG. 2 is a view schematically showing the structure of a diet management server 100 and a database 200 connected thereto, configuring a diet management system according to an embodiment of the present invention;

As shown in FIG. 2, the diet management server 100 includes a data transmission and reception unit 110 and a control unit 120.

The data transmission and reception unit 110 of the diet management server 100 may transmit and receive data to and from the user terminal 10, the information input terminal 20 and the database 200.

The control unit 120 may control general operation of the server and perform predetermined operations. The control unit 120 includes a body type classification operation unit 121 for creating a body type classification data by classifying a user by body type according to an obesity level and a body shape using a state diagnosis data, a lifestyle analysis unit 122 for creating a lifestyle analysis result of the user according to a lifestyle data, a solution creation unit 123 for creating a user-specific tailor-made solution appropriate to a diet goal of the user using a solution data DB 260 according to the lifestyle analysis result, the current state of the user and the state diagnosis data, and a personalized service providing unit 124 for receiving the current state of the user and transmitting the tailor-made solution modified to be suitable for the current state of the user to the user.

The database 200 receives data from a data transmission unit 11 (>> the data transmission and reception unit 110) and stores the data in each DB. The database 200 according to the present invention is configured of a user personal information DB 210 and the solution data DB 260, and the user personal information DB 210 includes a profile data DB 220 for storing basic information data such as a name, a sex, an age and the like of a user, a lifestyle data DB 230 for storing data such as living habits of the user, a motive of diet, hindrance of diet and the like, a state diagnosis data DB 240 for storing data such as a BMI of the user, a result of three-dimensional body shape analysis, a result of skin diagnosis and the like, and a body type classification data DB 250 for storing the body type classification data of the user. The solution data DB 260 stores a variety of solution data including items such as diet, product, exercise, massage and equipment.

Specific operation of the diet management server 100 and the database 200 is described below.

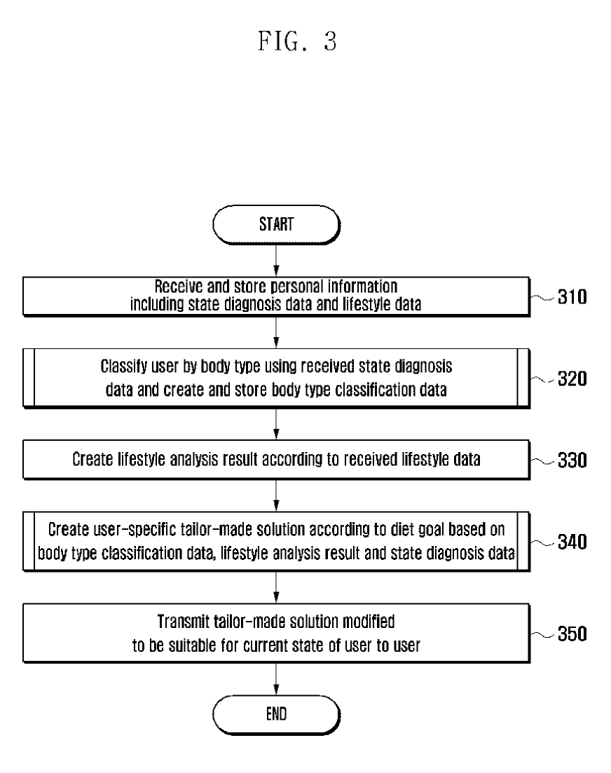

FIG. 3 is a flowchart illustrating the operation of the diet management server 100 and the database 200 in a diet management system according to an embodiment of the present invention. Although a step of the service provider for acquiring personal information from users is not shown in FIG. 3, since a method of acquiring personal information is specifically described in the above description of the diet management system, details thereof will be omitted in the following descriptions. The steps shown in FIG. 3 are steps executed after personal information is computerized and input into the information input terminal 20.

In step 310, the diet management server 100 receives personal information data of a user from the information input terminal 20 through the data transmission and reception unit 110. As described above, the personal information data according to an embodiment of the present invention includes a state diagnosis data and a lifestyle data. The diet management server 100 transmits the received personal information data to the database 200 through the data transmission and reception unit 110 to store the personal information data in the personal information data DB 210. At this point, the state diagnosis data is stored in the state diagnosis data DB, and the lifestyle data is stored in the lifestyle data DB.

Then, the diet management server 100 proceeds to step 320 to create a body type classification data by classifying the user by body type according to an obesity level and a body shape using the received state diagnosis data and transmit the body type classification data to the database 200 through the data transmission and reception unit 110 to store the body type classification data in the body type classification data DB.

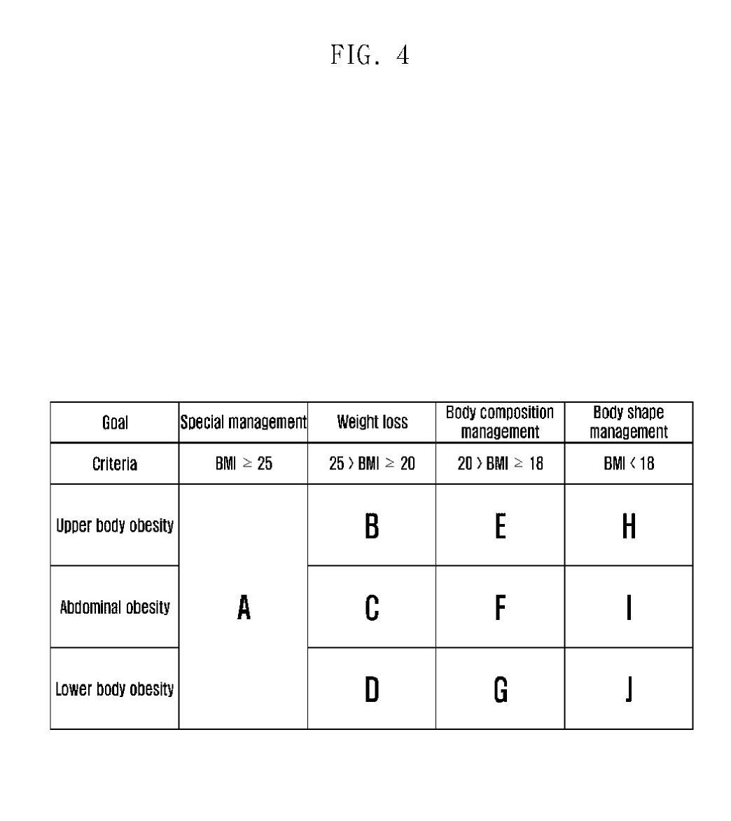

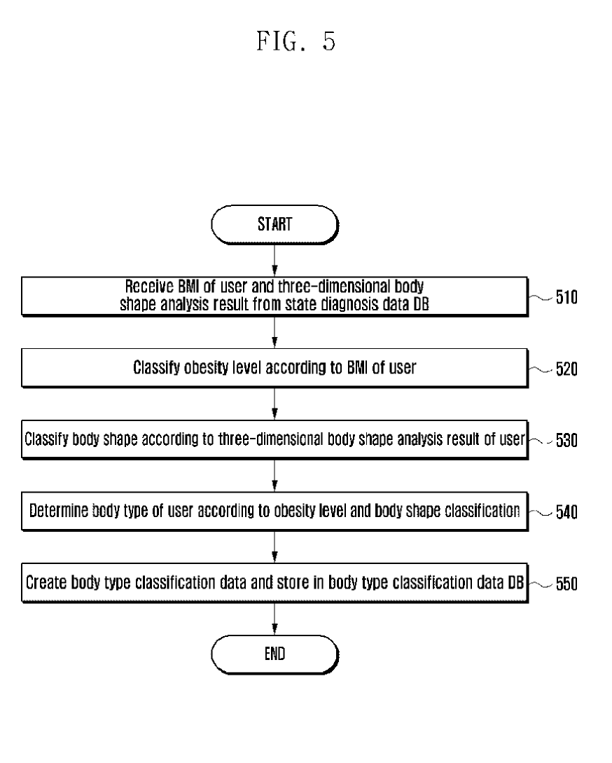

FIG. 4 is a table showing body type classification criteria according to an embodiment of the present invention, and FIG. 5 is a detailed flowchart of step 320 shown in FIG. 3, and these will be described with reference to FIGS. 4 and 5.

First, referring to FIG. 5, in step 510, the diet management server 100 receives a state diagnosis data of a user from the state diagnosis data DB included in the personal information data DB of the database 200 through the data transmission and reception unit 110.

In step 520, the body type classification operation unit 121 of the diet management server 100 classifies an obesity level according to the BMI included in the state diagnosis data of the user. The obesity level is divided into a first level of a BMI over 25, a second level of a BMI between 20 and 25, a third level of a BMI between 18 and 20, and a fourth level of a BMI under 18, according to the BMI. The criteria of the obesity level classification are set for Korean women and may be differently applied according to a classification method based on a sex, a race, a people or the like. In step 530, the body type classification operation unit 121 of the diet management server 100 classifies a body shape into an upper body obesity type, an abdominal obesity type and a lower body obesity type according to a result of three-dimensional body shape analysis included in the state diagnosis data of the user.

In step 540, a body type of the user is determined according to the obesity level classification and the body shape classification. In relation to this, according to FIG. 4, in the case of the first level of a BMI over 25, the body type is uniformly set as type A without detailed classification of the body shape. In the case of the second level of a BMI between 20 and 25, the body type is determined as type B, type C or type D according to the upper body obesity type, the abdominal obesity type or the lower body obesity type. In the same manner, in the case of the third level of a BMI between 18 and 20, the body type is determined as type E, type F or type G according to the upper body obesity type, the abdominal obesity type or the lower body obesity type, and in the case of the fourth level of a BMI under 18, the body type is also determined as type H, type I or type J according to the upper body obesity type, the abdominal obesity type or the lower body obesity type.

Next, in step 550, the body type classification operation unit 121 of the diet management server 100 creates a body type classification data according to the body type and stores the body type classification data in the body type classification data DB included in the personal information data DB of the database 200 through the data transmission and reception unit 110.

Returning to the description of FIG. 3 again, in step 330, the lifestyle analysis unit 122 of the diet management server 100 creates a lifestyle analysis result according to the received lifestyle data. The lifestyle analysis unit 122 analyzes living habits of the user, a motive of diet, hindrance of diet and the like.

The living habits of the user are obtained by analyzing recent body symptoms, preferred and disliked food, preferred and disliked exercise and the like, and the motive of diet is obtained by analyzing a situation requiring a diet, a reason of diet and the like, and the hindrance of diet is obtained by analyzing appetite, number of times of taking a snack, frequency of having a party, whether or not drinking alcohol and the like, and this is determined based on the contents of a questionnaire initially answered by the user.

Next, in step 340, the solution creation unit 123 of the diet management server 100 creates a user-specific tailor-made solution using the solution data DB according to a diet goal of the user, the lifestyle analysis result and the state diagnosis data based on the body type classification data.

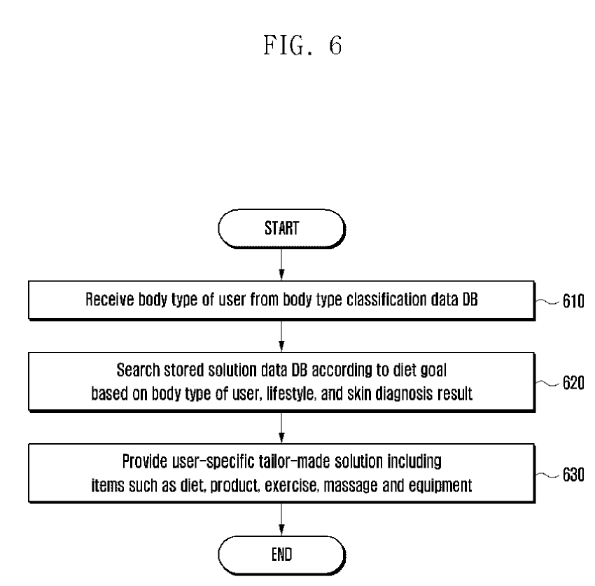

FIG. 6 shows detailed steps configuring step 340 shown in FIG. 3, and this will be described with reference to FIG. 6.

In step 610, the diet management server 100 receives a body type classification data of a user from the body type classification data DB in the personal information data DB of the database 200 through the data transmission and reception unit 110.

Next, in step 620, the diet management server 100 searches the solution data DB 260 stored in the database 200 according to the diet goal, the living habits and the skin diagnosis result according to the body type of the user. The diet goal is determined according to the body type of the user determined in step 320. The diet goal is loss of weight when the body type of the user is A, B, C or D, i.e., the obesity level of the user is the first or second level, management of body composition when the body type of the user is E, F or G, i.e., the obesity level of the user is the third level, and management of body shape when the body type of the user is H, I or J, i.e., the obesity level of the user is the fourth level. When the obesity level is the first or second level, loss of weight is the goal, but the goal of the first level is further severe loss of weight.

In addition, in relation to the living habits, food and exercise preferred by the user, food and exercise disliked by the user and the like are considered. A solution currently needed for the user is searched for also considering the skin diagnosis result.

In step 630, the solution creation unit 123 of the diet management server 100 provides a user-specific tailor-made solution including items such as diet, product, exercise, massage and equipment based on a result of searching the solution data DB 260.

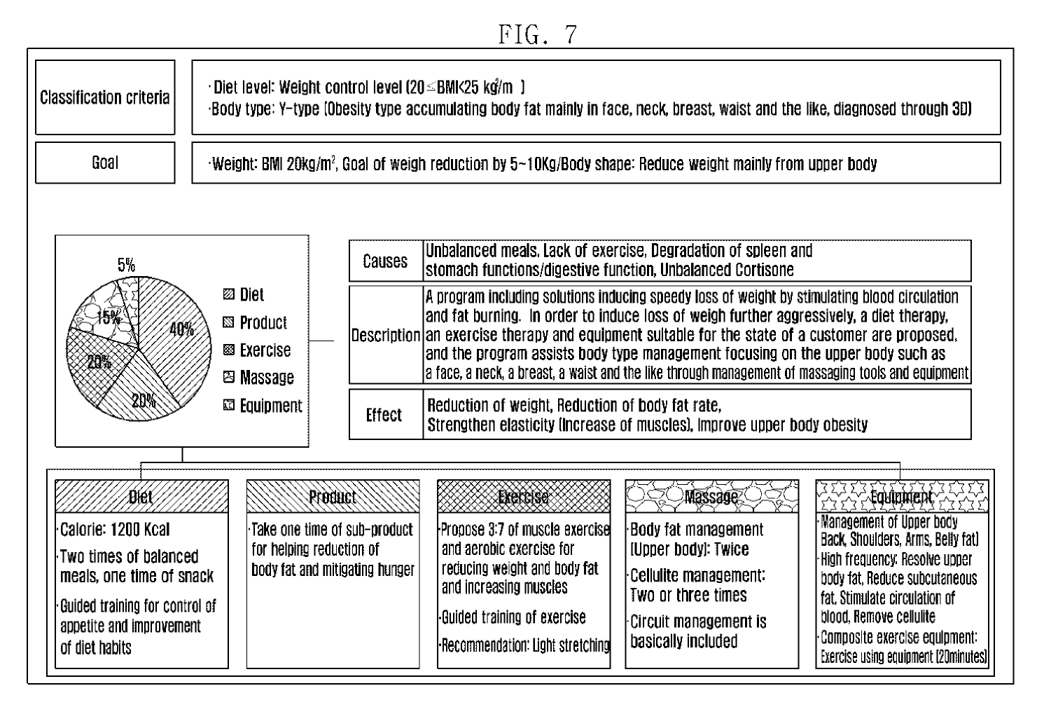

FIG. 7 is a view schematically showing an example of an output screen of a tailor-made solution according to an embodiment of the present invention.

According to FIG. 7, a body type of a user separated into a BMI and a body shape is output in the classification criteria field of the output screen, and a diet goal according thereto is output. In addition, proportions occupied by the diet, product, exercise, massage and equipment in a diet program are shown in a graph, and causes of obesity, descriptions on the solution and effects of the solution are output. In addition, items such as diet, product, exercise, massage and equipment are output.

The diet item is related to food taken by the user and presents the type and calories of the food, a guide to diet habits and the like. The product item presents a substitute food to be taken for diet. The exercise item presents an exercise procedure and an exercise training focusing on an exercise preferred by the user, and the massage item presents body portions to be managed and a method for managing the body portions according to a skin diagnosis result. The equipment item presents health supporting equipment or the like needed according to a diet goal.

Additionally, the solution creation unit 123 may create a tailor-made solution with reference to tailor-made solutions of other users included in lifestyle data of other users after acquiring the lifestyle data of other users having a lifestyle similar to the lifestyle analysis result by searching the lifestyle data DB.

Returning to the description of FIG. 3 again, in step 350, the personalized service providing unit 124 of the diet management server 100 receives the current state of the user and provides the tailor-made solution modified to be suitable for the current state of the user.

The personalized service providing unit 124 of the diet management server 100 first receives the current state of the user from the user terminal 10 through the data transmission and reception unit 110. The current state of the user is input and transmitted by the user through the user terminal 10. Then, if the solution creation unit modifies the tailor-made solution considering the current state of the user, the modified tailor-made solution is transmitted through the data transmission and reception unit 110. Accordingly, the user may timely receive the tailor-made solution modified to be suitable for the current state of the user and enhance the effect of diet.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A diet management system comprising:
a database for storing a personal information data including a state diagnosis data and a lifestyle data of a user received from a diet management server and a solution data;
the diet management server including a data transmission and reception unit connected to communicate with the database, an information input terminal and a user terminal and capable of transmitting and receiving data, a body type classification operation unit for creating a body type classification data by classifying the user by body type according to an obesity level and a body shape using the state diagnosis data received through the data transmission and reception unit, a lifestyle analysis unit for creating a lifestyle analysis result of the user according to the lifestyle data received through the data transmission and reception unit, a solution creation unit for creating or modifying a user-specific tailor-made solution appropriate to a diet goal of the user based on the body type classification data using a solution data DB according to the lifestyle analysis result or a current state of the user and the state diagnosis data, and a personalized service providing unit for receiving the current state of the user from the user terminal through the data transmission and reception unit and transmitting the tailor-made solution modified to be suitable for the current state of the user to the user terminal through the data transmission and reception unit;
the information input terminal connected to communicate with the diet management server and inputting the personal information data of the user; and
the user terminal connected to communicate with the diet management server and capable of receiving the current state of the user from the user and outputting the modified tailor-made solution.

2. The system according to claim 1, wherein the database further includes the body type classification data created by classifying the user according to the obesity level and the body shape.

3. The system according to claim 1, further comprising a web server connected to communicate with the diet management server, the information input terminal and the user terminal.

4. The system according to claim 3, wherein the web server receives the personal information data from the information input terminal, transmits the received personal information data to the data transmission and reception unit of the diet management server, receives the current state of the user from the user terminal, transmits the received current state of the user to the data transmission and reception unit of the diet management server, receives the modified tailor-made solution from the data transmission and reception unit of the diet management server, and transmits the received modified tailor-made solution to the user terminal.

5. The system according to claim 1, wherein the information input terminal and the user terminal are the same terminal.

6. The system according to claim 1, wherein the diagnosis data includes a BMI of the user, a result of three-dimensional body shape analysis and a result of skin diagnosis.

7. The system according to claim 6, wherein when the body type is classified, the body type classification operation unit classifies the obesity level according to the BMI and classifies the body shape according to the result of three-dimensional body shape analysis.

8. The system according to claim 7, wherein when the obesity level is classified according to the BMI, the body type classification operation unit classifies the obesity level into a first level of a BMI over 25, a second level of a BMI between 20 and 25, a third level of a BMI between 18 and 20, and a fourth level of a BMI under 18, and when the body shape is classified, the body type classification operation unit classifies the body shape into an upper body obesity type, an abdominal obesity type, a lower body obesity type according to the result of three-dimensional body shape analysis of the user.

9. The system according to claim 8, wherein the diet goal is loss of weight when the obesity level of the user is the first or second level, management of body composition when the obesity level of the user is the third level, and management of body shape when the obesity level of the user is the fourth level.

10. The system according to claim 1, wherein the lifestyle analysis unit analyzes living habits of the user by analyzing the lifestyle data, a motive of diet of the user and hindrance of the diet.

11. The system according to claim 1, wherein the solution creation unit provides the user-specific tailor-made solution including any one or more items of diet, product, exercise, massage and equipment.

12. The system according to claim 1, wherein the solution creation unit creates the tailor-made solution with reference to tailor-made solutions of other users included in lifestyle data of other users after acquiring the lifestyle data of other users having a lifestyle similar to the lifestyle analysis result by searching a lifestyle data DB.

13. A diet management method of a diet management system including a diet management server, a database connected to the diet management server and storing a personal information data including a state diagnosis data and a lifestyle data of a user received from the server and a solution data, an information input terminal connected to communicate with the diet management server and inputting the personal information data, and a user terminal connected to communicate with the diet management server and capable of receiving a current state of the user from the user and outputting a modified tailor-made solution,
the method comprising the steps of:
(a) creating a body type classification data by classifying the user by body type according to an obesity level and a body shape using the state diagnosis data received from a state diagnosis data DB through a data transmission and reception unit of the diet management server, and storing the created body type classification data into a body type classification data DB of the database;
(b) creating a lifestyle analysis result of the user according to the lifestyle data of the user received from a lifestyle data DB through the data transmission and reception unit of the diet management server;
(c) creating a user-specific tailor-made solution appropriate to a diet goal of the user based on the body type classification data using a stored solution data DB according to the lifestyle analysis result and the state diagnosis data, by the diet management server; and
(d) receiving the current state of the user from the user terminal through the data transmission and reception unit of the diet management server, modifying the tailor-made solution to be suitable for the current state of the user, and transmitting the tailor-made solution modified to be suitable for the current state of the user to the user terminal through the data transmission and reception unit.

14. The method according to claim 13, wherein the diet management system further includes a web server connected to communicate with the diet management server, the information input terminal and the user terminal, and step (e) includes the steps of:
receiving the current state of the user from the user terminal and transmitting the received current state of the user to the data transmission and reception unit of the diet management server, by the web server; and
receiving the modified tailor-made solution from the data transmission and reception unit of the diet management server and transmitting the received modified tailor-made solution to the user terminal, by the web server.

15. The method according to claim 13, wherein the information input terminal and the user terminal are the same terminal.

16. The method according to claim 13, wherein the diagnosis data includes a BMI of the user, a result of three-dimensional body shape analysis and a result of skin diagnosis.

17. The method according to claim 16, wherein step (a) includes the steps of:
(a-1) classifying the obesity level according to the BMI; and
(a-2) classifying the body shape according to the result of three-dimensional body shape analysis.

18. The method according to claim 17, wherein
step (a-1) is a step of classifying the obesity level into a first level of a BMI over 25, a second level of a BMI between 20 and 25, a third level of a BMI between 18 and 20, and a fourth level of a BMI under 18, and
step (a-2) is a step of classifying the body shape into an upper body obesity type, an abdominal obesity type, a lower body obesity type according to the result of three-dimensional body shape analysis of the user.

19. The method according to claim 18, wherein the diet goal is loss of weight when the obesity level of the user is the first or second level, management of body composition when the obesity level of the user is the third level, and management of body shape when the obesity level of the user is the fourth level.

20. The method according to claim 13, wherein step (b) includes the steps of:
analyzing living habits of the user by analyzing the lifestyle data; and
analyzing a motive of diet of the user and hindrance of the diet.

21. The method according to claim 13, wherein step (c) includes the step of providing a user-specific tailor-made solution including any one or more items of diet, product, exercise, massage and equipment.

22. The method according to claim 13, wherein step (d) includes the steps of:
acquiring the lifestyle data of other users having a lifestyle similar to the lifestyle analysis result by searching a lifestyle data DB; and
creating the tailor-made solution with reference to tailor-made solutions of other users included in lifestyle data of other users.

23. A diet management method of a diet management server connected to an information terminal, a user terminal and a database,
the method comprising the steps of:
(a) creating a body type classification data by classifying the user by body type according to an obesity level and a body shape using the state diagnosis data received from the database through a data transmission and reception unit of the diet management server, and storing the created body type classification data into a body type classification data DB of the database;
(b) creating a lifestyle analysis result of the user according to the lifestyle data of the user received from the database through the data transmission and reception unit of the diet management server;
(c) creating a user-specific tailor-made solution appropriate to a diet goal of the user based on the body type classification data using a stored solution data DB according to the lifestyle analysis result and the state diagnosis data, by the diet management server; and
(d) receiving the current state of the user from the user terminal through the data transmission and reception unit of the diet management server, modifying the tailor-made solution to be suitable for the current state of the user, and transmitting the tailor-made solution modified to be suitable for the current state of the user to the user terminal through the data transmission and reception unit.
